(19) United States
(12) Patent Application Publication
(10) Pub. No.: US 2015/0269865 A1
(43) Pub. Date: Sep. 24, 2015

(54) SYSTEMS AND METHODS FOR PERSONALIZED NUTRIMERS

(71) Applicants: Dotan VOLACH, Haifa (IL); Inbal LANDSBERG, Herzlia (IL); Arina SHAINSKI, Ramat-HaSharon (IL)

(72) Inventors: Dotan VOLACH, Haifa (IL); Inbal LANDSBERG, Herzlia (IL); Arina SHAINSKI, Ramat-HaSharon (IL)

(21) Appl. No.: 14/662,333

(22) Filed: Mar. 19, 2015

Related U.S. Application Data
(60) Provisional application No. 61/955,312, filed on Mar. 19, 2014.

(51) Int. Cl. G09B 19/00

(52) U.S. Cl. CPC G09B 19/0092

(57) ABSTRACT

According to an aspect of some embodiments of the present invention there is provided a computer-implemented method for selecting at least one nutrimer for a subject, the method being carried out by a nutrimer matching unit programmed to carry out the steps of the method, which comprise: receiving at least one genetic variation of a subject; automatically matching the at least one genetic variation with at least one nutrimer using a nutrimer correlation database storing a plurality of correlations of genetic variations with nutrimers; and generating a signal indicative of the at least one matched nutrimer.

### RELATED APPLICATION

This application claims the benefit of priority under 35 USC 119(e) of U.S. Provisional Patent Application No. 61/955,312 filed Mar. 19, 2014, the contents of which are incorporated herein by reference in their entirety.

### FIELD AND BACKGROUND OF THE PRESENT INVENTION

The present invention, in some embodiments thereof, relates to systems and methods for personalized nutrimers and, more particularly, but not exclusively, to automatic systems for matching nutrimers with a genetic profile of a subject.

Nutrients such as vitamins, minerals, fatty acids, amino acids, antioxidants and other types of supplements are key to the health of living organisms such as humans, animals and plants. Over 40 different supplements are needed for healthy normal functions of the human body. These include water-soluble vitamins (such as biotin, folates, niacin, pantothenic acid, riboflavin, thiamin, vitamin B6, cobalamine and vitamin C), fat-soluble vitamins (such as vitamin A, vitamin D, vitamin E and vitamin K), minerals (such as Calcium, Chloride, Magnesium, Phosphorus, Potassium, Sodium and Sulfur) and trace minerals (such as Chromium, Copper, Fluoride, Iodine, Iron, Manganese, Molybdenum, Selenium and Zinc) to name a few. Nutrient classification is based on dosing requirements. Nutrients are often classified as essential and non-essential by the organism's ability to synthesize a sufficient amount of the nutrient. Alternatively, nutrients are classified as macronutrients and micronutrients by the amount required by the organism (milligrams versus micrograms).

Supplementation dosage guidelines are typically composed and provided by governmental health units such as the Office of Dietary Supplements (ODS) which is part of the National Institute of Health (NIH) in the United States, the EURopean micronutrient RECommendations Aligned (EURRECA), which was funded by the European Commission, non-governmental organization such as the world health organization (WHO) and research institutes focused on public health such as the Linus Pauling Institute. According to the Food and Nutrition Board (FNB) at the Institute of Medicine of the National Academies (formerly National Academy of Sciences), dosing guidelines are collectively referred to as Dietary Reference Intake (DRI). DRI is the general term for a set of reference values used for planning and assessing the nutrient intakes of healthy people. DRI includes:
1. Recommended Dietary Allowance (RDA): average daily level of intake sufficient to meet the nutrient requirements of nearly all (97%-98%) healthy individuals.
2. Adequate Intake (AI): Established when evidence is insufficient to develop an RDA and is set at a level assumed to ensure nutritional adequacy.
3. Estimated Average Requirement (EAR): Average daily level of intake estimated to meet the requirements of 50% of healthy individuals. It is usually used to assess the adequacy of nutrient intakes in populations but not individuals.
4. Tolerable Upper Intake Level (UL): Maximum daily intake unlikely to cause adverse health effects.

The RDAs, unlike their former guidelines, the Recommended Dietary Intakes (RDIs), account for age and gender as well as pregnancy and lactation status. Table 1 is an example of Calcium RDAs provided by the NIH through the Office of Dietary Supplements. The RDAs in Table 1 are provided according to the above mentioned grouping criteria. AIs are presented wherever RDAs were not established.

TABLE 1
Recommended Dietary Allowances (RDAs)
for Calcium

| Age | | Male | Female | Pregnant | Lactating |
|---|---|---|---|---|---|
| 0-6 | months* | 200 mg | 200 mg | | |
| 7-12 | months* | 260 mg | 260 mg | | |
| 1-3 | years | 700 mg | 700 mg | | |
| 4-8 | years | 1,000 mg | 1,000 mg | | |
| 9-13 | years | 1,300 mg | 1,300 mg | | |
| 14-18 | years | 1,300 mg | 1,300 mg | 1,300 mg | 1,300 mg |
| 19-50 | years | 1,000 mg | 1,000 mg | 1,000 mg | 1,000 mg |
| 51-70 | years | 1,000 mg | 1,200 mg | | |
| 71+ | years | 1,200 mg | 1,200 mg | | |

*Adequate Intake (AI)

RDAs are set to accommodate nutrient dosage requirements of an entire population. The required nutrient amount of a specific individual may vary, for example, according to the genetic makeup of the individual. Individualized nutrient supplementation dosing needs have been estimated by various methods such as: functional testing (for instance blood or hair sample tests), skin impedance measurements, body fat determinations, body mass index (BMI), genetic testing, and food intake assessment based on questionnaires.

Assessed individualized RDAs are often presented to a user as end result informative data. RDAs are often presented as a recommended dosage in milligrams or micrograms. Alternatively, RDAs are used for determining nutrient dosages in personal compounding systems. Compounding may be accomplished by a nutritionist by mixing powders or accomplished by an automatic system for supplement manufacturing.

Marini et al., U.S. Patent Application Publication No. 2012/0277180 disclose “methods and systems for identifying one or more cofactors such as vitamins for individuals based on the genetic makeup of the individual by detecting the presence or absence of at least one genetic variant, determining a predisposition to cofactor remediable condition, generating a personalized nutritional advice plan based on the genetic variant”.

### SUMMARY OF THE PRESENT INVENTION

An aspect of some embodiments of the present invention relates to methods and systems for automatically matching a genetic variation of a subject with at least one nutrimer.

According to an aspect of some embodiments of the present invention there is provided a computer-implemented method for selecting at least one nutrimer for a subject, the method being carried out by a nutrimer matching unit programmed to carry out the steps of the method, which comprise: receiving at least one genetic variation of a subject; automatically matching the at least one genetic variation with at least one nutrimer using a nutrimer correlation database storing a plurality of correlations of genetic variations with nutrimers; and generating a signal indicative of the at least one matched nutrimer.

Optionally, the method further comprises generating a recommended plan for administration of the at least one matched nutrimer to the subject. Optionally, the recommended plan comprises one or more of: an amount of each of the nutrimers, a consumption pattern of the nutrimers, and a frequency of administration of the nutrimers.

Optionally, the method further comprises retrieving recommended doses for the nutrimer-genetic variation correlation and generating the recommended administration plan according to the recommended dose.

Optionally, outputting comprises generating alerts indicative of the recommended administration plan to a mobile device of the subject.

Optionally, the method further comprises automatically managing the administration of the recommended plan.

Optionally, the method further comprises receiving from a user at least one preference related to the recommended administration plan, and dynamically changing the recommended administration plan according to the at least one preference. Optionally, the at least one preference is in response to change in health status of the subject.

Optionally, the recommended administration plan comprises a booster stage and a maintenance stage.

Optionally, the method further comprises receiving intake diet information of the subject, subtracting the intake diet information from the recommended plan to obtain a difference, and providing the difference as one or more supplemental products.

Optionally, the recommended plan includes a diet based on the matched nutrimers.

Optionally, the method further comprises monitoring for changes in the correlations of genetic variations with nutrimers and generating a new recommended administration plan accordingly.

Optionally, the nutrimer comprises at least one of: a vitamer, a mineral sub-type, an herbal sub-type, and a spices sub-type.

Optionally, the method further comprises calculating a score for the at least one matched nutrimer based on desirability of administering the at least one matched nutrimer to the subject. Optionally, the scores are based one or more of: metabolic pathways, metabolic products, bioavailability, side effects, costs, risk of toxicity, therapeutic effects, source, and manufacturing process.

Optionally, the automatically matching is performed according to at least one of a nutrimer profile and a subject profile. Optionally, the nutrimer profile comprises at least one of: method of administration, bioavailability, toxicity, substance release mode, intake along with food, antagonist effect, agonist effect, source, manufacturing process, expiration date and inventory status; and the subject profile comprises at least one of: budget range, preferred method of administration, gender, age, pregnancy status, lactation status, physical activity, stress level, known allergies, suspected allergies, prescribed medications, over the counter drugs, eating habits, medical conditions, family history and medical history.

Optionally, the method further comprises assigning a product score to available products based on product profiles of the available products wherein the available products contain the at least one matched nutrimer, and wherein automatically matching comprises automatically matching the at least one genetic variation based on the product score.

Optionally, the subject is presumably healthy and the automatically matching is performed to maintain the health of the subject using the matched nutrimers.

Optionally, the method further comprises receiving nutrimer ingredient data of at least one commercially available supplemental products; classifying each of the commercially available supplemental products according to the nutrimer ingredient data; and selecting at least one of the classified commercially available supplemental products according to the correlated nutrimer. Optionally, selecting is performed according to a product profile comprising at least one of: method of product administration, period of administration, frequency of administration, substance release mode, brand and cost. Optionally, the method further comprises providing instructions for combining the commercially available supplemental products into a recommended administration plan.

Optionally, automatically matching comprises automatically matching a combination of multiple genetic variations to a single nutrimer.

Optionally, automatically matching comprises automatically matching a single genetic variation to multiple nutrimers.

Optionally, the method further comprises integrating multiple nutrimer-genetic variation correlations into a nutrimer regimen comprising a set of multiple nutritional supplements for intake by the subject.

Optionally, automatically matching comprises automatically matching according to nutrimer-nutrimer interactions.

Optionally, the method further comprises receiving a medical profile of the subject including prescribed medications, and generating a recommended plan for administration of the at least one matched nutrimer to the subject in accordance with the medical profile. Optionally, automatically matching comprises automatically matching according to medication-nutrimer interactions.

Optionally, automatically matching comprises matching the nutrimers according to an indirect supplementation protocol.

Optionally, automatically matching comprises matching the nutrimers according to epistasis.

Optionally, automatically matching comprises matching according to clinical guidelines and/or according to health organization recommendations.

Optionally, the method further comprises receiving from a user at least one rule for the respective matching, and dynamically changing the at least one matched nutrimer based on the received at least one rule.

Optionally, matching further comprises matching according to a dietary intake based nutrimer profile that indicates which nutrimer and amount is to be administered for: different ages, gender, pregnancy status, and/or lactation status.

Optionally, the method further comprises monitoring for changes in the correlations of genetic variations with nutrimers and generating at least one new matched nutrimer accordingly.

Optionally, the method further comprises receiving input from an operator to modify one or both of a nutrimer profile and a subject profile.

According to an aspect of some embodiments of the present invention there is provided a system for automatic matching of at least one nutrimer according to a genetic profile of a subject, the system comprising: a hardware processor; and a non-transitory memory having stored thereon program modules for instruction execution by the hardware processor, comprising: a nutrimer correlation database storing correlations of genetic variations with nutrimers; and a nutrimer matching module for matching at least one genetic variation of a subject with at least one nutrimer using the nutrimer correlation database.

Optionally, the system further comprises a recommendation plan generation module for generating a recommended plan for administration of the at least one nutrimer to the subject.

Optionally, the system further comprises an input interface for allowing an operator to modify one or both of a nutrimer profile and a subject profile.

Optionally, the system further comprises a network interface for connecting to a network, and further comprising an update module for accessing a remote server using the network interface to obtain data for updating the nutrimer correlation database.

According to an aspect of some embodiments of the present invention there is provided a method for generating a kit of structures for enteral administration comprising: receiving at least one genetic variation of a subject; automatically matching the at least one genetic variation with at least one nutrimer; receiving nutrimer ingredient data of at least one commercially available supplemental products; selecting at least one of the commercially available supplemental products according to the at least one matched nutrimer; and forming structures for enteral administration out of the commercially available supplemental products having the at least one matched nutrimers.

Optionally, the method further comprises generating a recommended plan for administration of the at least one matched nutrimer to the subject based on the formed structures for enteral administration.

Unless otherwise defined, all technical and/or scientific terms used herein have the same meaning as commonly understood by one of ordinary skill in the art to which the present invention pertains. Although methods and materials similar or equivalent to those described herein can be used in the practice or testing of embodiments of the present invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the present invention can involve performing or completing selected tasks manually, automatically, or a combination thereof. Moreover, according to actual instrumentation and equipment of embodiments of the method and/or system of the present invention, several selected tasks could be implemented by hardware, by software or by firmware or by a combination thereof using an operating system.

For example, hardware for performing selected tasks according to embodiments of the present invention could be implemented as a chip or a circuit. As software, selected tasks according to embodiments of the present invention could be implemented as a plurality of software instructions being executed by a computer using any suitable operating system. In an exemplary embodiment of the present invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWING(S)

Some embodiments of the present invention are herein described, by way of example only, with reference to the accompanying drawings. With specific reference now to the drawings in detail, it is stressed that the particulars shown are by way of example and for purposes of illustrative discussion of embodiments of the present invention. In this regard, the description taken with the drawings makes apparent to those skilled in the art how embodiments of the present invention may be practiced.

In the drawings:

FIG. 1 is a schematic of vitamin B12 nutrimers, according to some embodiments of the present invention;

FIG. 2 is a block diagram of an exemplary system for automatically correlating a genetic variation with nutrimers, according to some embodiments of the present invention;

FIG. 3 is a graph depicting vitamin B12 absorbance by a human subject as a function of dose, according to some embodiments of the present invention;

FIG. 4A is a decision tree for selecting B12 nutrimer products for treating anemia secondary to vitamin B12 deficiency, according to some embodiments of the present invention;

FIG. 4B is a decision tree for selecting iron nutrimer products for treating anemia secondary to iron deficiency, according to some embodiments of the present invention;

FIG. 5 is a graph depicting the desired feature of having nutrimer B within a lower and upper threshold dose range, according to some embodiments of the present invention;

FIG. 6 is a graph depicting optimal, acceptable and/or undesired sections according to selection factors, according to some embodiments of the present invention;

FIG. 7 is a flowchart of an exemplary method for automatically correlating a genetic variation with nutrimers, according to some embodiments of the present invention; and

FIG. 8 is a detailed flowchart of the method of classifying supplemental products of FIG. 7 according to some embodiments of the present invention.

### DESCRIPTION OF EMBODIMENTS OF THE PRESENT INVENTION

The present invention, in some embodiments thereof, relates to systems and methods personalized nutrimers and, more particularly, but not exclusively, to automatic systems for matching nutrimers with a genetic profile of a subject according to particular nutrient forms while accounting for a subject profile and/or a nutrimer profile.

As used herein, the term nutrimer means a non-energy providing nutrient of a particular structural form varying by chemical structure and/or structure arrangement (enantiomer). Different nutrimer forms may have different properties in the same subject and/or in different subjects, for example, in subjects having genetic variability associated with the nutrimer. A nutrimer may or may not have a nutrient activity in a nutrient deficient subject. A nutrimer may have an activity profile with respect to one or more biochemical activities. For example, Lutein does not possess vitamin A activity, but possesses antioxidant activity (specifically, protection from high-energy photons of blue light). For example, the nutrient cobalamine (vitamin B12) has four nutrimers: cyanocobalamin, hydroxycobalamain, methylcobalamin and adenocobalamin. The term nutrimer further refers to particular forms of vitamins, minerals, metals, antioxidants and/or amino acids etc. For example, calcium carbonate, calcium citrate, calcium phosphate, calcium lactate, calcium glucanate and dolomite are calcium nutrimers. Similarly, alpha linolenic acid (ALA), Docosahexaenoic acid (DHA) and Eicosapentaenoic acid (EPA) are omega-3 nutrimers. A sub-structure of a nutrient which differs between two or more nutrimers is typically referred to as an R group. The R group is not the structural section used to define the nutrient. For example, Calcium salts are nutrients defined by a calcium ion. The R group of calcium salts may be carbonate, citrate or other ions, but does not include the Calcium ion itself. Nutrimers may have the exact same chemical formula, but different three dimensional arrangement. One such example is the enantiomers 1-alpha-tocopherol and d-alpha-tocopherol. Some nutrimers are functionally equivalent (for example, binding as co-factors to the same enzymes) while others are not. Nutrimers may further differ, for example, by stability, metabolism, bioavailability and/or excretion.

Nutrimers may not be restricted to enantiomers (i.e., having a different structural form). Nutrimers may have different chemical formula. Sometimes, nutrimers are referred to by exclusion, for example, nutrimers may be selected based on not having activity in deficient subjects. For example, products may be recommended to subjects (e.g., as part of the recommended administration plan) based on lacking in certain nutrimers. Lack of nutrimers may be desirable, for example, when the subject has limited ability to process a nutrimer, the subject has limited ability to eliminate a nutrimer and/or the subject is allergic to the nutrimer. The lack of nutrimer may be reflected by a suitable score and/or rank.

Nutrimer is a generalization of the term vitamer to further comprise nutrients other than vitamins. The term vitamer was first coined at the Gibson Island Vitamin Conference and reported in 1943 in Science magazine in an article titled “Heat-labile, avidin-uncombinable, species-specific and other vitamers of biotin” by Dean Burk and Richard Winzler (Science 15 Jan. 1943: 57-60). Since it was coined the term was used bearing two meanings which were used interchangeably: 1) Related vitamin structures which are structurally similar but not identical 2) Types of vitamins which carry the same function. This dichotomy of term usage is clearly demonstrated, for example, by the definition of vitamer in the Merriam-Webster's Collegiate Dictionary, 11th edition (ISBN-13: 978-0877796367): “Any of two or more compounds that relieve a particular vitamin deficiency; also: a structural analog of a vitamin”.

The nutrimer may comprise a vitamer, a mineral sub-type, an herbal sub-type, a spices sub-type, and/or other suitable sub-types.

An aspect of some embodiments of the present invention relates to a computer-implemented method for selecting one or more nutrimers for a subject, the method comprising automatically matching one or more genetic variations of the subject with one or more nutrimers. Optionally, the correlation is performed according to a nutrimer correlation database storing correlations of genetic variations with nutrimers. Optionally, nutrimers expected to have enhanced properties in subjects with the genetic variation are administered to the subject, as compared to, for example, other nutrimers and/or combination thereof.

Optionally, a recommendation plan for administration of the nutrimers is automatically generated for the subject. The plan includes, for example, an amount of each nutrimer for administration, a pattern of administration, a frequency of administration, a diet of foods containing the nutrimer, other factors and/or combinations thereof.

Optionally, the health of the subject is maintained and/or improved by the administration of the correlated nutrimers, as compared to, for example, other nutrimers and/or combinations thereof. Alternatively or additionally, there are other benefits in selecting the matched nutrimer, for example, reduced costs, easier administration route, or other factors. Optionally, the administration plan is adjusted in response to the changing health of the subject.

Optionally, the genetic variation is correlated with the nutrimer according to a score indicative of a desirability of administering the at least one nutrimer to the subject with the at least one genetic variation. Scores are based on, for example, metabolic pathways, metabolic products, bioavailability, side effects, costs, risk of toxicity, therapeutic effects, source, manufacturing process, and/or other factors.

Optionally, the matching is performed according to a nutrimer profile. The nutrimer profile may denote properties of the nutrimer and/or effects of the nutrimer, for example, method of administration, bioavailability, toxicity, substance release mode, intake along with food, antagonist effect, agonist effect, source, manufacturing process, expiration date, inventory status, other parameters and/or combinations thereof.

Alternatively or additionally, the matching is performed according to a subject profile. The subject profile may denote variables associated with the subject, for example, budget range, preferred method of administration, gender, age, pregnancy status, lactation status, physical activity, stress level, known allergies, suspected allergies, prescribed medications, over the counter drugs, eating habits, medical conditions, family history, medical history, other parameters and/or combinations thereof.

Optionally, a medical profile of the subject is received, for example, from an electronic medical record (EMR), from generated targeted questions about medicines which are in interaction with the suggested vitamers, or other methods. The medical profile of the subject may include, for example, prescribed medications, over the counter drugs, supplements, allergies, and/or other factors along with their respective administration information comprising compliance with medications, when medications are taken (e.g., what time of day), how medications are consumed (e.g., enteral administration, intravenous administration), with what foods.

Optionally, the nutrimer and/or subject profile take into account additional medical and/or genetic factors, as described hereinabove. Alternatively or additionally, the nutrimer and/or subject profile take into account non-medical factors, for example, logistic, economic, or other factors, as described hereinabove.

Optionally, one genetic variation is matched with several nutrimers. Alternatively or additionally, several genetic variations are matched with one nutrimer. Alternatively or additionally, several genetic variations are matched with several nutrimers. Optionally, several nutrimers are combined into a single treatment plan.

Optionally, the matching of nutrimers is performed for a healthy subject. For example, the matching may be performed to maintain the health of the subject by the administration of the nutrimer. Alternatively or additionally, the matching of nutrimers is performed for a subject diagnosed with a medical condition. The matching may be performed to get to the subject to a healthy state by the administration of the nutrimer.

Optionally, ingredient data of commercially available supplemental products is received. Optionally, the products are classified according to the received data. Optionally, one or more of the classified supplemental products are selected for administration to the patient in a combination to obtain the correlated nutrimer. Optionally, different doses of the commercially available supplemental products are selected for administration. Optionally, the commercially available supplemental products are combined into a customized treatment regimen as part of the recommendation plan, for example, instructions are provided to the user on the sub-dose of each product. Optionally, specialized manufacturing is not required to obtain the customized treatment regimen. Alternatively, the customized treatment regimen is specifically manufactured.

Optionally, a kit of structures for enteral administration is generated. The structures for enteral administration include, for example, pills, soft pills, chewables, lozenges, or other structures for gastrointestinal absorption and/or oral administration. Optionally, pills are formed according to the selected combinations of supplemental products, the pills having amounts of nutrimers according to the generated recommended administration plan.

Before explaining at least one embodiment of the present invention in detail, it is to be understood that the present invention is not necessarily limited in its application to the details of construction and the arrangement of the components and/or methods set forth in the following description and/or illustrated in the drawings and/or the Examples. The present invention is capable of other embodiments or of being practiced or carried out in various ways.

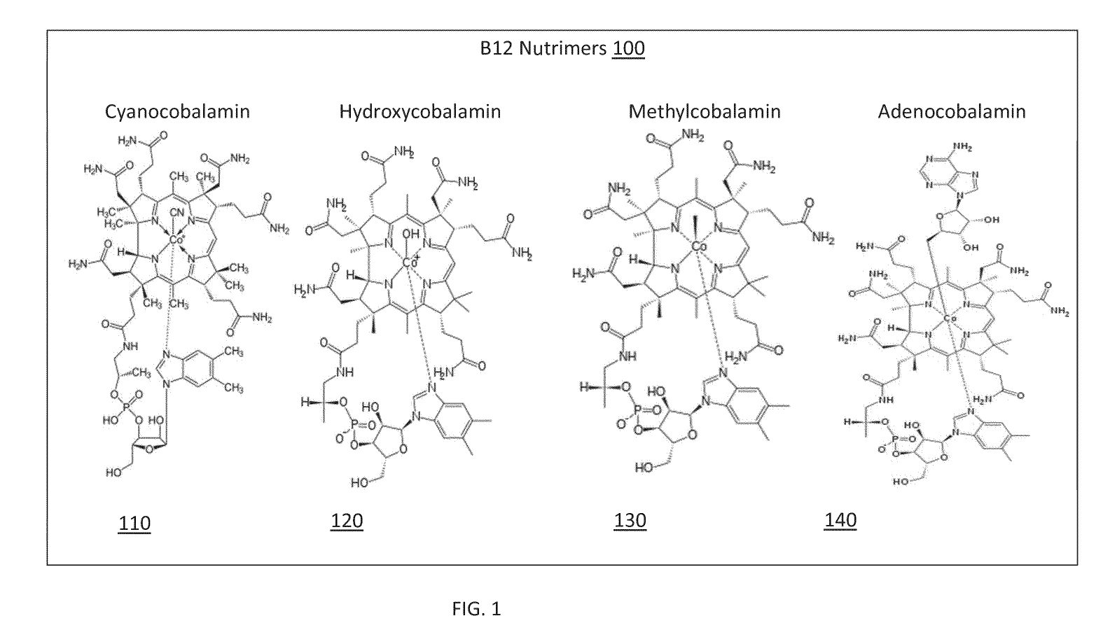

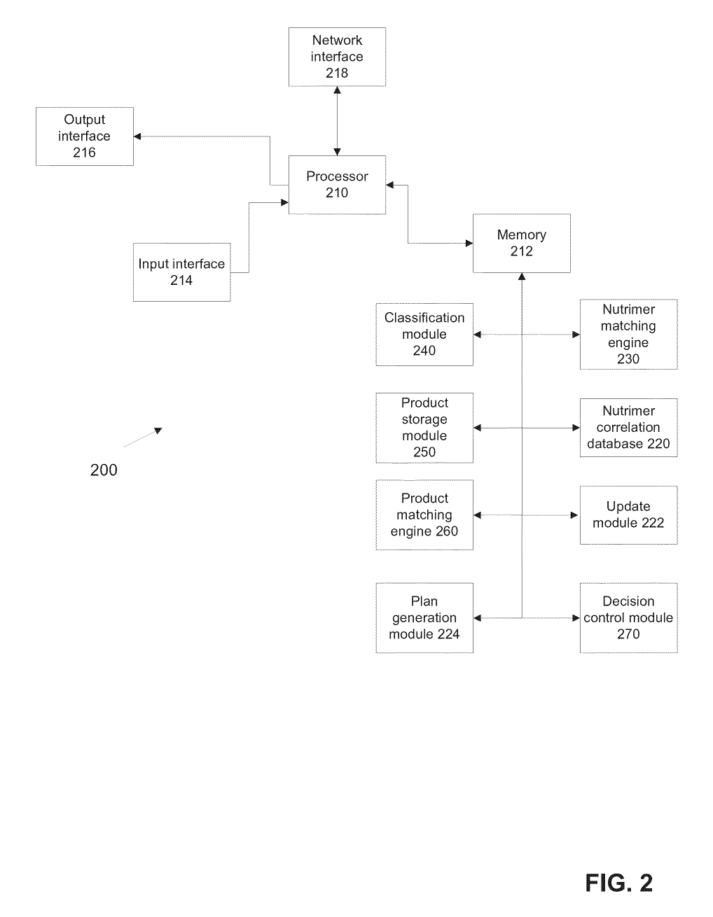

For purposes of better understanding some embodiments of the present invention, as illustrated in FIGS. 2-6 of the drawings, reference is first made to an exemplary vitamer as illustrated in FIG. 1.

FIG. 1 is a schematic illustrating four vitamers of cobalamin 100, in accordance with some embodiments of the present invention. The vitamin cobalamin 100, more commonly known as B12, is the largest and most structurally complicated vitamin. Vitamin B12 100 consists of a class of chemically related compounds (vitamers) 110, 120, 130 and 140. All four B12 vitamers 110-140 contain the biochemically rare element cobalt. The B12 vitamers 110-140 differ by an R group connected to the cobalt. This R group may be a cyanide creating cyanocobalamin 110, hydroxyl creating hydroxycobalamin 120, methyl creating methylcobalamin 130 and 5′-deoxyadenosyl creating adenocobalamin 140. Only two 130-140 of the four B12 vitamers 110-140 are physiological forms in humans. Commercial production of B12 vitamers starts with bacteria or archibacteria production of hydroxycobalamin 120. Most humans are able to convert this B12 form 120 into B12 physiological forms 130-140 required for normal function. Cyanocobalamin 110 is generated in a synthetic process by adding cyanide to a hydroxycobalamin 120. Cyanocobalamin 110 does not occur in nature. The advantages of cyanocobalamin 110 are its stability and lower production cost. However, removing the cyanide group requires methyl groups' usage which may deplete the body of this important nutrient. All of the above mentioned B12 vitamers 110-140 possess vitamin B12 activity.

Reference is now made to FIG. 2, which is a block diagram of an exemplary system 200 for automatically correlating nutrimer(s) with a genetic profile of a subject, in accordance with some embodiments of the present invention. The nutrimer matching system 200 comprises a hardware processor 210, and a non-transient memory 212 storing thereon program modules for instruction execution by processor 210: a nutrimer correlation database 220 for storing correlations between nutrimers and genetic variations, and a nutrimer matching engine 230 for matching genetic variations with nutrimers characteristics comprising: nutrimers (nutrient sub-type), nutrimers dose and/or nutrimers administration methods using database 220. Relations between genetic variation(s) and nutrimer(s) are curated, for example, from sources such as peer reviewed articles from scientific journals, clinical trials and/or independent lab tests.

Optionally, genetic variations matches with nutrimers are calculated on the fly rather than stored in a database and/or other accessible storage means.

As used herein, the term genetic variation means an inter individual difference of an inherited component, for example a Small Nucleotide Polymorphism (SNP), a micro deletion, a micro insertion, a deletion, an insertion, an inversion, a translocation, loss of heterozygosity, a rearrangement, a duplication, tandem repeat polymorphism, epigenetic patterns, and/or other differences. A nutrimer(s)—genetic variation(s) relationship may comprise, for example, ranking of nutrimer compatibility with genetic variation(s), usage exclusion of a nutrimer for genetic variation(s) etc. The relations between genetic variation(s) and nutrimer(s) are stored in nutrimer correlation database 220. Optionally, a nutrimer(s)—genetic variation(s) relationship further comprises recommended dosing of a specific nutrimer. The dosing may be provided according to categories such as age, gender, weight, specie, or other categories. Optionally, a formula for calculating the dosage is provided. Optionally, the Nutrimer(s)—genetic variation(s) relationship comprises increased dosage requirements due to, for example, decreased processing ability, malfunctioned transportation, decreased binding activity of target, and/or modified calculation of nutrimer bioavailability and/or dosage contribution.

An exemplary relationship of folate nutrimers and a genetic variation in Methylene Tetra Hydro Folate Reductase (MTHFR) gene is provided in Tables 2 and 3. These tables refer to SNP number rs1801133 in the MTHFR gene also referred to as C677T, Ala222Val, and A222V. The wild type (w.t.) genotype of this SNP (CC) indicates normal MTHFR activity. The heterozygote genotype of this SNP (CT) indicates 65% activity of MTHFR compared to wild type. The homozygote genotype of this SNP (TT) indicates 30% activity of MTHFR compared to wild type. MTHFR metabolizes a rate limiting step in the folate pathway. MTHFR is involved in metabolizing folic acid and/or folinic acid into the active form S-5-methyl folate. MTHFR polymorphisms (CT, TT) may keep B9 vitamers (folic acid and folinic acid) from being metabolized into their active form, folate. This may lead to the potentially harmful accumulation of homocysteine and/or low availability of folate. High homocysteine is a risk factor for coronary artery disease, rendering a person more prone to endothelial injury. High homocysteine has been correlated with the occurrence of blood clots. Low Folate availability may cause pregnancy complications, cognitive declines, mental depression, sore or swollen tongue, peptic or mouth ulcers, headaches, heart palpitations, irritability, and/or behavioral disorders among other symptoms and conditions.

Folates may be found in supplements as 3 main nutrimers: folic acid, folinic acid and/or methyl folate. These nutrimers differ from each other, for example, in their cofactor activity, metabolism, bioavailability, cost, upper intake limit, side effects, stability, therapeutic effect and/or other nutrimer features.

Some examples of nutrimer specific features are listed on Table 4. According to these features different nutrimers are matched to different rs1801133 genotypes. An example of such a match is provided in Table 2. The folate nutrimers are given a score, for example, on a scale of −5 until +5. Scores may be manually entered and/or automatically calculated by software. Positive scores indicate level of match to the genotype (more positive better match). Negative scores indicate an undesired nutrimer for the related genotype. For example, a person having the wild type genotype for rs1801133 (CC) would benefit the most from a folinic acid supplement while a homozygote individual (TT) should avoid this nutrimer, and supplement with methyl-folate instead. Optionally, a dosage accompanies each genotype-nutrimer combination as shown, for example, in Table 3. The recommended methyl folate dose for a subject having the genotype CC, CT or TT is 400 micrograms (mcg), 500 mcg and 800 mcg respectively. Optionally, nutrimer specific dosage accounts, for example, for age, gender, specie, weight, height, body fat, food intake, dietary preferences (such as vegetarian, vegan), supplementation of other nutrients (accounting for nutrimer-nutrimer interaction), medications (for example, birth control pills, antibiotics), health conditions (for example, cancer, mal absorption diseases as Crohn's disease and Celiac), melanin pigmentation, sun exposure, smoking, dietary restrictions (for example low sodium diet), water fluoride content, mental status (e.g., depression), and/or other factors.

TABLE 2
Genotype-Folate correlation scores

| | Methyl- | Folinic | |
|---|---|---|---|
| Genotype | Folate | acid | Folic acid |
| CC (w.t.) | 2 | 3 | 1 |
| CT (hetero) | 2 | −1 | −2 |
| TT (homo) | 2 | −1 | −2 |

TABLE 3
Genotype-Folate correlation dosages

| | Methyl- | Folinic | Folic |
|---|---|---|---|
| Genotype | Folate | acid | Acid |
| CC (w.t.) | 400 mcg | 800 mcg | 400 mcg |
| CT (hetero) | 500 mcg | 800 mcg | 800 mcg |
| TT (homo) | 800 mcg | 800 mcg | 800 mcg |

TABLE 4
Exemplary folate nutrimer properties

| | Methyl- | | |
|---|---|---|---|
| Property | Folate | Folinic acid | Folic acid (FA) |
| Cofactor | Cofactor of | Not a cofactor. | Not a cofactor. |
| | MTHFR | Needs to be | Needs to be |
| | | metabolized into | metabolized into |
| | | Methyl folate | Methyl folate |
| Metabolism | None | PMID 9630738: | PMID23482308: |
| | | Bypasses de- | “Supplemental FA |
| | | conjugation and | must be reduced to |
| | | reduction steps | dihydrofolate |
| | | required for folic | (DHF) and then to |
| | | acid | tetrahydrofolate |
| | | | (THF) to be able |
| | | | to enter the folate |
| | | | cycle and act as a |
| | | | co-factor and a |
| | | | source |
| | | | for methyl groups |
| | | | in the cell.” |
| bioavailability | 100% | PMID 3257913 | PMID23482308: |
| | | Human absorption | Un-metabolized FA |
| | | kinetic studies | appears in the |
| | | of orally | circulation at doses |
| | | administered folinic | of >200 μg |
| | | acid have | |
| | | demonstrated a | |
| | | bioavailability of | |
| | | 92% | |
| | | PMID 9630738 | |
| | | readily transported | |
| | | through the blood | |
| | | brain barrier into | |
| | | the central | |
| | | nervous system | |
| Average 400 mcg | 0.12 | 0.07 | 0.04 |
| pill Cost | | | |
| $US | | | |
| Side effects | | | PMID23482308: |
| | | | “does not mask |
| | | | vitamin B 12 |
| | | | deficiency” |
| Upper limit | PMID23482308 | | PMID23482308: |
| | “In contrast | | “The tolerable |
| | to FA, 5- | | upper intake level |
| | methylTHF | | (UL) for FA is 1 mg/ |
| | has no | | day” |
| | tolerable | | |
| | upper intake” | | |
| Stability | | PMID 9630738 | PMID23482308 |
| | | longer half-life in | “In contrast to |
| | | the body than folic | natural forms of |
| | | acid | folate in the diet, |
| | | | FA is more stable |
| | | | upon exposure to |
| | | | heat.” |
| Therapeutic | | PMID 9630738 | |
| effects | | Folinic acid also | |
| | | appears to be a | |
| | | more metabolically | |
| | | active form of | |
| | | folate, capable of | |
| | | boosting levels of | |
| | | the coenzyme | |
| | | forms of the | |
| | | vitamin in | |
| | | circumstances | |
| | | where folic acid has | |
| | | little to no effect. | |

Nutrimer(s)—genetic variation(s) relationships may have different relative quantities: for example, a combination of multiple genetic variations may be related to a single nutrimer, a single genetic variation may be related to multiple nutrimers, or other relationships. These relationships are stored in nutrimer correlation database 220. The relationships may be stored in a file system, a relational database, a graph database, a tree, a record, or other suitable data structures.

Optionally, scientific evidences supporting a relationship are stored along with the nutrimer(s)-genetic variation(s) relationships. Optionally, scientific supporting evidence is stored at nutrimer correlation database 220. Optionally, supporting evidence are tagged, classified into predetermined categories, and/or summarized. Optionally, reliability measurement(s) are provided for supporting evidence. For example, the subject number used to draw a conclusion of evidence is used as an input to a reliability measurement. Additional optional input data for a reliability measurement may comprise: duplication of a result by independent research, type of study (prospective cohort, retrospective cohort, time series study, case-control study, in-vivo study, in-vitro kinetics study, in-vitro dynamics study and/or in-vitro binding study etc.).

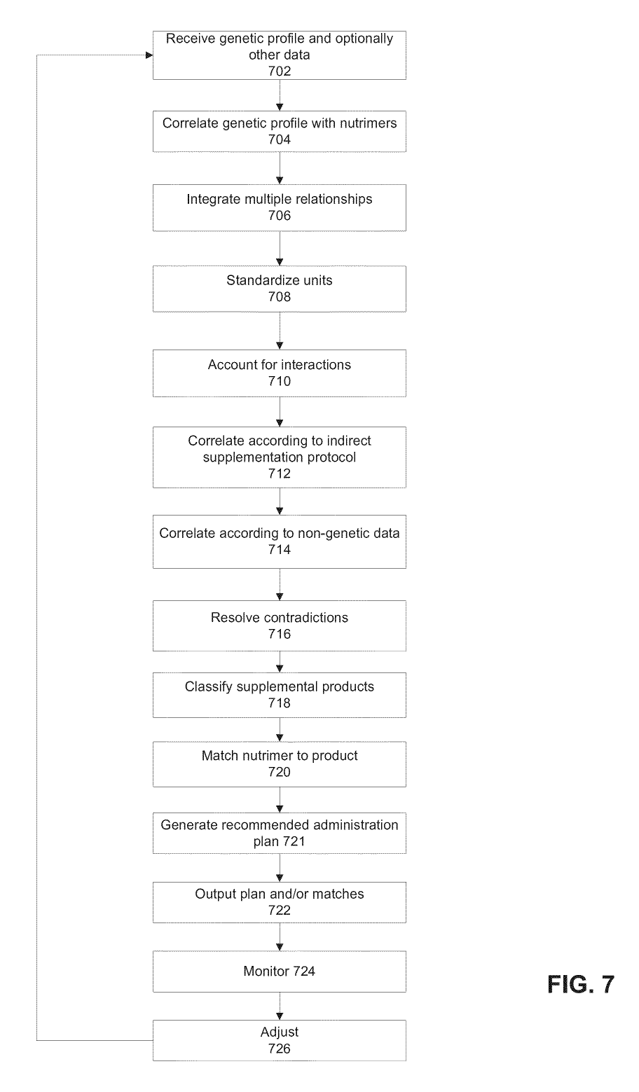

Reference is now made to FIG. 7, which is a flowchart of a computer-implemented method of matching genetic variations and nutrimers, in accordance with some embodiments of the present invention. The method may be carried out, for example, by system 200 of FIG. 2, having a nutrimer matching engine 230 programmed to carry out at least some steps of the method. Optionally, a correlation database provides nutrimer matching data instead of, or in addition to, the nutrimer matching engine 230 for at least one nutrimer. Other suitable methods and/or software applications may be used to perform the matching.

At 702, nutrimer matching engine 230 receives a genetic profile of a subject being evaluated for suitable nutrimers. The genetic profile is comprised of genetic variations as captured by genetic variation descriptors. Alternatively, engine 230 receives the genetic variations. Variation descriptors may be selected from, but are not limited to, sequences such as: full genome sequences, exome sequences, selected gene sequences, polymerase chain reaction (PCR) sequences, microarray results, yeast complementation assays and other methods indicating genetic variation at the Deoxyribonucleic acid (DNA), Ribonucleic acid (RNA), protein and/or activity level.

Optionally, the genetic profile includes multiple profiles from more than one person, for example, a family profile. Optionally, genetic contributing factors are assessed based on the family history, family nutrimer status (e.g., known deficiencies, medical conditions, and/or other factors).

Optionally, one or more additional factors are also received. For example, a medical profile of the medical history of the subject, preferences of the subject, or other factors as will be described in additional detail below.

The genetic profile and/or additional factors may be received, for example, by being entered by the user, downloaded from a remote server using a network connection, loaded from a file saved on an external memory, and/or other methods.

At 704, nutrimer matching engine 230 uses the received genetic variation(s) from the genetic profile to access the relationships stored in nutrimer correlation database 220.

Optionally, the matching is performed according a dietary intake based nutrimer profile that indicates which nutrimer and/or the amount of nutrimer to be administered for: different ages, gender, pregnancy status, lactation status, or other recommended dietary intakes. Optionally, the nutrimer profile is a population average profile. Optionally, the nutrimer profile is indication as a modification over a population average profile. For example, “below average”, “like average” and “above average” tags are selected by a user to indicate the nutrimer profile in a simple way.

Optionally, at 706, nutrimer matching engine 230 integrates multiple nutrimers—genetic profile relationships into at least one nutrimer recommendation. Alternatively or additionally, nutrimer matching engine 230 integrates multiple nutrimers—genetic profile relationships into a nutrimer regimen. As used herein, the term regimen means a set of multiple nutritional supplements comprising supplemental intake of a subject. The nutrimer regimen may comprise dosages, mode of administration (sublingual, oral, nasal, muscle injection etc.). The nutrimer regimen may comprise time of administration (two pills taken together, one pill in morning and one pill in evening, slow release pill etc.). Time of administration may relate to health events (two days after last antibiotic dose, seven days before first day of menstruation). The nutrimer regimen may comprise intake frequency (once a week, every day, once a month etc.). The nutrimer regimen may comprise instructions for time distance from food consumption (with meal, at least two hours after meal, no more than an hour before a meal).

Optionally, at 708, nutrimer matching engine 230 standardizes the amounts of a nutrient of interest in a nutrimer specific way, for example, according to measuring units of the nutrimer. Optionally, standardization is performed prior to the correlation of block 704.

For some nutrients, different nutrimers may have different conversion rates to standardized nutrient units. For example, Vitamin A standardized units are retinol activity equivalents (RAEs). In order to translate an amount of Beta-carotene, a vitamin A nutrimer, to RAEs the following nutrimer specific conversion factors are used:
1. Beta-carotene has a conversion factor of 0.6 mcg to 1 International Units (IU) of vitamin.
2. 10 IU of vitamin A from beta-carotene equals one retinol equivalent (RE).
3. 0.5 RAE equals 1 retinol equivalent (RE).
   In comparison, retinol, a different vitamin A nutrimer, is converted to RAEs standardized units using different conversion factors:

1 mcg retinol=1 RAE vitamin A=1 RE vitamin A=3.33 I.U. vitamin A

The nutrimer matching engine 230 standardizes the amounts of a nutrient of interest in a nutrimer specific way. Optionally, standardization is performed prior to matching. Optionally, a single nutrimer contributes to more than a single standardized unit. For example calcium chloride contributes to calcium standardized units as well as to chloride standardized units.

Optionally, at 710, nutrimer matching engine 230 accounts for nutrient-nutrient interactions. For example, according to Wapnir and Balkman (United States National Library of Medicine Identifier (PMID) 1726403), zinc inhibits copper absorption. The Copper form (i.e. copper nutrimer) is determined by the zinc dosage in the regimen. For example, a zinc free regimen is matched with a generic cheaper copper form, while a zinc containing regimen is matched with a chelated copper nutrimer such as copper glycinate chelate. Optionally, nutrimers are grouped together and a nutrimer(s)-genetic variation(s) relationships matches genetic variation(s) with a nutrimers group. For example, a nutrimer group may be “none vitamin a carotenoids” comprising lutein, zeaxanthin, meso-zeaxanthin and the like.

Optionally, the nutrient-nutrient interactions are nutrimer specific.

Optionally, the nutrient-nutrient interactions are part of the correlation of block 704. For example, block 710 may be performed before, or with block 704.

Different zinc threshold levels may be used for matching copper nutrimers. Each zinc level may be related to a list of copper nutrimers. Each list may be a ranked list. Optionally, the dosage of copper is corrected by nutrimer matching engine 230 according to administered zinc.

Optionally, nutrient-nutrient interactions involve more than two nutrients. For example, Histidine enhances the inhibitory effects of zinc on copper absorption. Copper levels may be determined by nutrimer matching engine 230 according to the combination of zinc and Histidine levels. Optionally, relevant zinc and Histidine levels are determined by a combination of one or more factors, such as supplement intake, food intake, genetic variation, exercise level, life style, or other factors.

Alternatively or additionally, at 710, nutrimer matching engine 230 accounts for drug-nutrimer interaction(s). Drugs may interact with nutrients and their nutrimers, for example, by affecting nutrimers absorption, by affecting absorption of other drugs, by affecting absorption of the interacting drug, bioavailability, metabolism, target binding, kinetics, dynamics and/or excretion. For example, Vitamin E interferes with the absorption of the antidepressant desipramine (Norpramin). Nutrimer matching engine 230 may exclude vitamin E from a regimen based on an indication of Norpramin usage.

Optionally, at 712, nutrimer matching engine 230 matches nutrients and/or nutrimers with genetic variation, food uptake, nutrient insufficiencies and/or nutrient deficiencies based on indirect supplementation protocols. Optionally, obtaining a healthy, desired nutrimer level is achieved by indirect supplementing.

As used herein, the term indirect supplementation means supplying a first nutrient (and/or nutrimer) in order to modify the level of a second nutrient (and/or nutrimer) in a subject. For example, Riboflavin (vitamin B2) may be supplied in order to increase the level of folate (vitamin B9), as Riboflavin is a co-factor of a key enzyme in the folate cycle (MTHFR). Indirect supplementation may also take a negative form, i.e. not supplying a first nutrient (and/or nutrimer) in order to modify the level of a second nutrient (and/or nutrimer) in a subject. For example, treating a human subject (even for a few months) with metformin, an oral anti-diabetic drug, may result in the decrease of vitamin B12 and folate. However, supplementation of vitamin B12 alone rather than the combination of vitamin B12 and folate might be profitable based on the mechanism of metformin on vitamins in patients with type 2 diabetes (PMID 23751310).

Multiple genetic variations, such as for example a double mutation, may change the phenotypic response of one another. In case of supplements, the nutrient form, dosage, method of administration and other features of a nutrimer profile may differ depending on the genetic background of a second mutation. This phenomenon, named epistasis, typically occurs when the genetic variations share a pathway. In a positive epistatic interaction, the phenotype of a multiple genetic variations is neutral or improved relative to the phenotype of a single genetic variation, while in a negative epistatic interaction the phenotype is an even stronger defect than would be expected in the case of nonrelated genetic variations. For example, Catechol-O-methyltransferase (COMT) and Regulator of G protein signaling 4 (RGS4) present functional epistasis (PMID 17895922). The Val/Val genotype of SNP rs4680 in COMT causes an elevated level of COMT activity (PMID 23966969). The elevated COMT level causes in turn a decrease in extracellular dopamine. In addition, the Val/Val genotype of SNP rs4680 in COMT reduces the messenger RNA (mRMA) of RGS4 (PMID 16905560). RGS4 in turn inhibits the dopamine receptor D2R which binds dopamine (PMID 21896332). The dopamine and/or tyrosine matched by the nutrimer matching engine 230 to a Val/Val genotype of SNP rs4680 in COMT is altered by the genetic variation of rs951436 in RGS4.

Optionally, at 714, generic nutrimer(s) knowledge, i.e. non-genetic knowledge, is incorporated into the matching process by nutrimer matching engine 230.

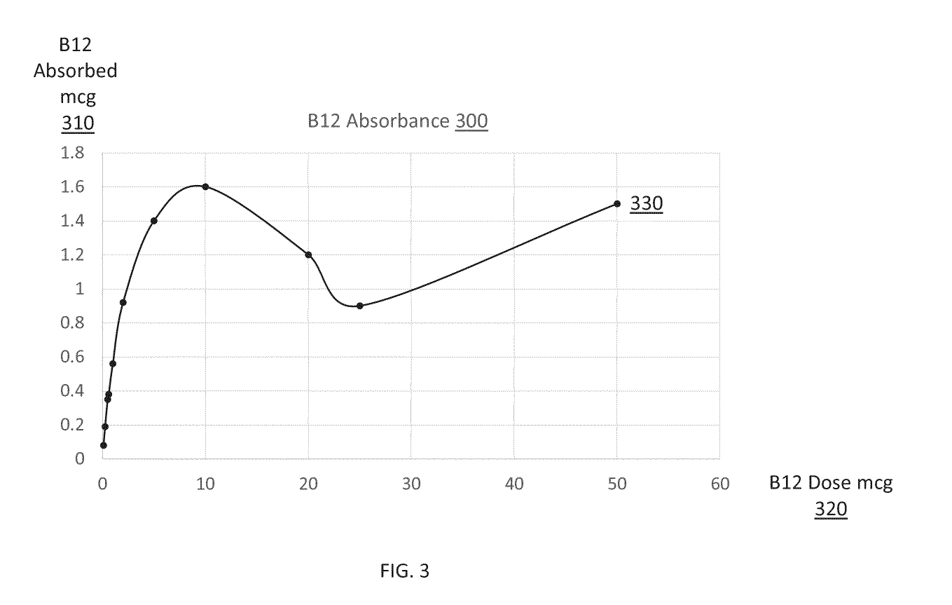

For example, Cholecalciferol (vitamin D3) is preferred over Ergocalciferol (vitamin D2) due to Cholecalciferol's ability to decrease mortality (PMID 21735411). In another example, copper oxide is avoided as its bio-availability is limited to nonexistent (PMID 7883634). In yet another example, vitamin B12 intake is limited to 10 mcg at a time due to declined absorbance of B12 at higher dosages (up to 50 mcg), as illustrated in FIG. 3.

FIG. 3 is a graph 300 depicting B12 absorbance by a human subject as a function of dose, in accordance with some embodiments of the present invention. Graph 300 is based on experimental results from PMID 3565293. The X axis 320 depicts the B12 intake dosage in micro grams (mcg). The Y axis 310 depicts the absorbed B12, based on blood level measurements. The relationship 330 between B12 intake and B12 absorbance is not a linear relationship. Until about 10 mcg B12 intake, the absorbed B12 shows a dose dependency relationship. However, above about 10 mcg the absorbance declines with increased supplementation. Despite the fact that no upper limit has been determined for B12 by the Office of Dietary Supplements (ODS), nutrimer matching engine 230 may prefer levels lower than about 10 mcg, in accordance with the above describe absorption pattern 330.

Optionally, matching is performed based on clinical guidelines (e.g., guidelines published in peer reviewed journals, guidelines of official medical associations, or other guidelines) and/or according to other published recommendations (e.g., health management organization recommendations, or recommendations by other health organizations). For example, clinical guidelines may recommend certain nutrimers as being healthy than others, clinical guidelines may recommend avoiding certain nutrimers for certain patients, or other guideline recommendations.

Optionally, at 716, nutrimer matching engine 230 resolves contradictions between different nutrimer recommendations. For example, if two different studies contradict each other with respect to the nutrimer to be administered to the subject, engine 230 may resolve the contradiction, for example, by referring to other studies which support one of the recommendations, by referring to a higher authority (e.g., clinical guidelines), and/or by evaluating the evidence level of the study (e.g., type of study, quality of study, assigned evidence grade).

Optionally, at 718, a classification module 240 (part of system 200 of FIG. 2) classifies the nutrimers of a supplement product, by processor 210 executing the program instructions of module 240.

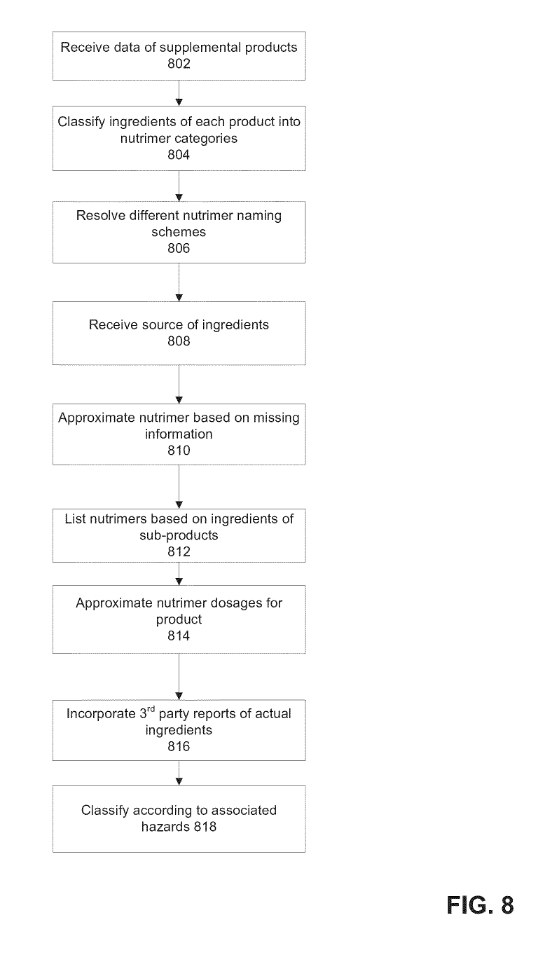

Attention is now diverted to FIG. 8, which is a detailed flowchart of the method of classifying supplemental products of block 718 of FIG. 7, according to some embodiments of the present invention.

At 802, classification module 240 receives data of supplement products, for example ingredient list, distributor, manufacturer, product title, label text, marketing material, or other data.

At 804, classification module 240 classifies the ingredients of each supplement product into nutrimer categories. Optionally, predefined nutrimer categories are used by classification module 240. Optionally, a nutrimer ontology is used by classification module 240 to classify supplement ingredients. Optionally, the supplement products are commercially available supplements, for example, as listed in catalogues of vitamins, supplements, enriched food, medical food, and/or health products manufacturers, distributors and/or sellers. Optionally the results of the classification module 240 are stored in a product storage module 250.

Optionally, at 806, classification module 240 resolves different naming schemes of nutrimers for enabling nutrimer matching by nutrimer matching engine 230. For example, Para-Aminobenzoic Acid is listed as either “Para-Aminobenzoic Acid”, “PABA” or both in ingredient lists of supplement products. Both of these terms may be mapped to a standardized name and/or identifier by classification module 240. Other examples are: P5P along with pyridoxal 5′ phosphate, and iron along with ferrous.

Optionally, at 808, classification module 240 receives as an input the source of an ingredient. An exemplary input is, “Vitamin B-6 (100 mg†; S. cerevisiae)”. The source is then identified, for example, as a natural source. Classification module 240 then applies source—nutrimer relationships in order to classify the nutrimer, for example, as in block 804. In the above mentioned example, the B6 nutrimer is classified as pyridoxal 5′ phosphate. In another example “folate from Broccoli” is classified as 5 Methyl Tetrahydrofolate.

Optionally, at 810, classification module 240 approximates a nutrimer based on missing information. Supplement providers may specify superior nutrimer ingredients and omit inferior nutrimer ingredients, so that missing information may be regarded as indicating usage of inferior ingredients. For example, “B12” and/or “cobalamin” are regarded as cyanocobalamin rather than hydroxy, adeno or methyl cobalamins. Similarly, when no enantiomer form is specified, a D and L mix may be assumed. For example, zinc mono methionine is classified as D+L form of methionine, while L-Methionine is classified as L form.

Optionally, at 812, classification module 240 lists nutrimers based on ingredients of sub-products. For example, OptiZinc® is classified as zinc D, L mono methionine.

Optionally, at 814, classification module 240 approximates nutrimer dosages when exact dosing information is unavailable for a supplement product. For example, ingredient listing of “Folate (Folic Acid, L-5-Methyltetrahydrofolate, 5-Formyltetrahydrofolate) 800 mcg” may be classified as:
Folic Acid 266.67 mcg
L-5-Methyltetrahydrofolate 266.67 mcg
5-Formyltetrahydrofolate 266.67 mcg

Optionally, the overall dosage (800 mcg) is divided equally between the three nutrimers. Alternatively, a dosage is divided unevenly between two or more nutrimers. The division ratios may be obtained, for example, from known divisions between nutrimers of the same manufacturer, from known divisions between nutrimers of other manufacturers and/or estimated based on product cost. Optionally, product cost estimation is applied when significant cost differences exist between nutrimers of the same nutrient. For example the average cost of folate is 4 times the cost of folic acid as detailed in Table 4.

Optionally, at 816, reports of actual ingredients as measured by third parties such as consumer labs and/or regulatory bodies are incorporated into the classification process by classification module 240. Discrepancies between actual nutrimer measurements and listed ingredients may be established and corrected for. Optionally, correction constants are used by the classification module 240 for each ingredient—product pair. Optionally, correction constants are used by the classification module 240 for each ingredient, independent of a specific supplement product. Optionally, correction constants are used by the classification module 240 for each combination of ingredient, nutrient and manufacturer/distributor.

Optionally, at 818, classification module 240 classifies products according to associated hazards. For example, frequency of lead and heavy metals in a supplemental fish oil is used to assess associated hazards. Amount and/or existence of magnesium stearate is used to assess associated hazards.

Referring now back to FIG. 7, optionally, at 720, the matched nutrimers (e.g., as in block 704) are match to one or more nutritional products. Optionally, nutrimer matching system 200 of FIG. 2 comprises a product matching engine 260 for matching supplement products to a subject. Product matching engine 260 may use nutrimer information stored at product storage module 250 and/or at nutrimer correlation database 220. The product matching engine 260 may uses processor 210 to execute program instructions of engine 260 to perform the nutrimer based match.

Optionally, the match between a nutrition product and a subject is based on the genetic profile of the subject received in block 702. Optionally, the match performed by the product matching engine may account for one or more additional received factors (e.g., in block 702). For example, product cost, daily product cost, product brand, desired supplement intake, food intake, exercise level, life style, functional test results (such as blood work, biome detection (for example detection in excretions and/or in gut), reported condition (such as diabetes, vitamin D insufficiency, copper deficiency etc.) and/or desired therapeutic goal such as, for example, lowering HDL, lowering homocysteine level, preparing for pregnancy etc. Optionally, the product matching engine 260 accounts for nutrimer dosages, method of administration, frequency of administration, and/or co-occurrence in a single intake, or other variables.

Optionally, product matching engine 260 performs a match between one or more supplemental products, ingredients of the products and their nutrimer profiles on one hand, and a subject profile on the other hand. Different matching methods may be used, for example, mapping to an N-dimensional space, matching using weights, matching using a decision tree, or other suitable methods.

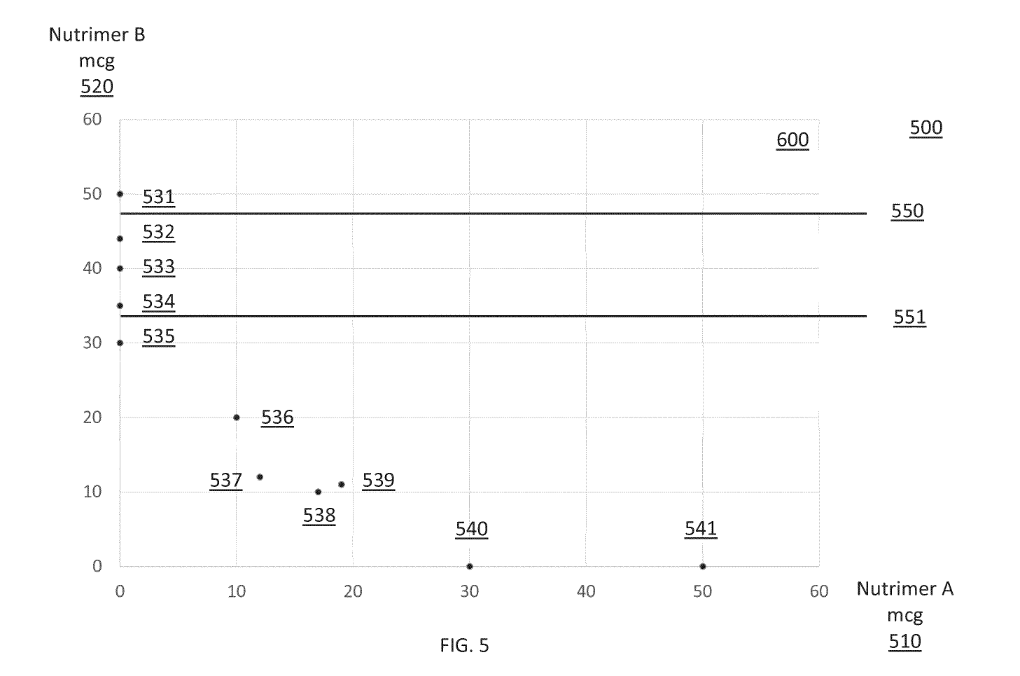

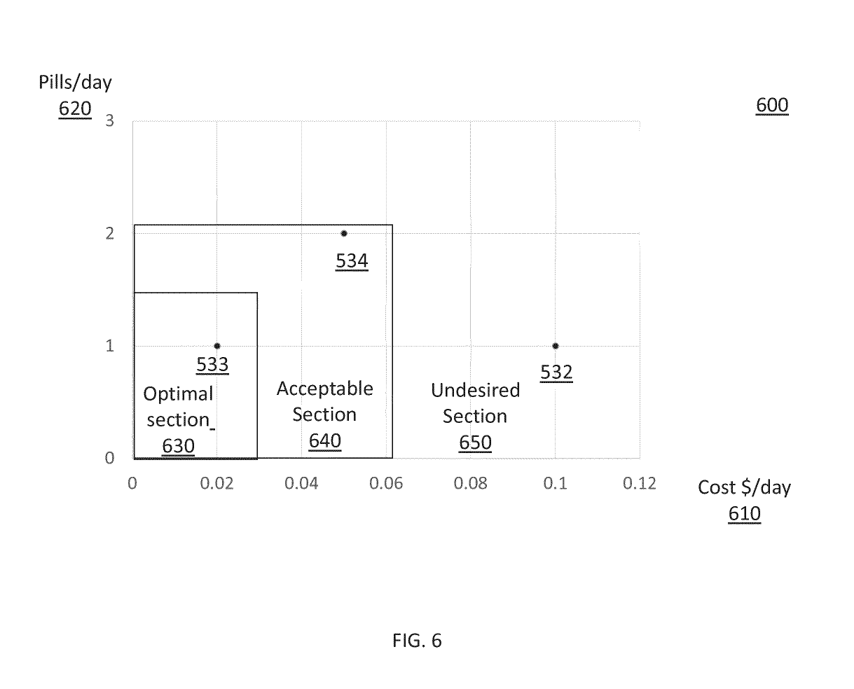

Optionally, product matching engine 260 defines boundaries of a desired area in an N-dimensional space. Each dimension of the space represents a feature of the product such as the product cost, the nutrimer, the dosage, the method of administration etc. The bounded area defined by the product matching engine 260 outlines a desired set of features for a product as illustrated in FIGS. 5 and 6. For example, FIG. 5 is a graph depicting the desired feature of having nutrimer B within a lower and upper threshold dose range, for example, in a dosage above the lower threshold of 33 mcg and below the upper threshold of 47 mcg, in accordance with some embodiments of the present invention.

In addition, FIG. 6 is a graph depicting three sections: an optimal section 630, an acceptable section 640, and/or an undesired section 650, in accordance with exemplary embodiments of the present invention. Sections 630, 640 and 650 are defined by a combination of two product features: for example, number of pills administered a day 620 (e.g., y-axis) and the daily cost 610 (e.g., x-axis).

Product matching engine 620 may map multiple nutrition products (e.g., vitamins, supplements, medical foods, fortified foods, foods) into the spaces (or similar spaces) as illustrated in FIGS. 5 and 6.

According to graph 500 depicted in FIG. 5 only 3 products 532-534 fall within the desired nutrimer thresholds. Optionally, the remaining products 531, 535-541 are deleted from the graph, ignored by the product matching engine 260, provided a low rank or score and/or not further mapped by other product and nutrimer profiles.

The mapping of products 532-534, which fulfill the nutrimer B threshold criteria, are further mapped in an N-dimensional space by daily cost 610 and the number of pills administered a day 620 of their respective products. A two dimensional (610, 620) graph 600 demonstrating two dimensions of such an N-dimensional space product mapping is illustrated in FIG. 6. The two dimensional sub-graph 600 defines three sections: optimal section 630, acceptable section 640 and undesired section 650. The products are ranked and presented to a user by their respective sections. Accordingly, product 533 would get the lowest rank and recommended over products 534 and 532. Optionally, product matching engine 260 sources the nutrition products from product storage module 250.

Optionally, product matching engine 260 performs a match between a product, its ingredients and their nutrimer profiles on one hand and a subject profile on the other hand using weighting formulas. Each feature of a nutrimer profile and/or a product profile is provided a weight with respect to a subject profile. Weights may be preset, manually entered by the user and/or automatically determined by software.

The product score may be assigned to available products based on weighted product profiles of the available products, where the available products contain the matched nutrimer. The automatic matching of the genetic variation and/or subject profile may be based on the calculated product score and/or the product profile.

The product may be scored according to an equation accounting for these features and their respective weights. For example, S1 denotes a score reflecting the suitability of a B12 nutrimer for the desired nutrimer for a genetic profile (as exemplified in Table 2). S2 denotes the directed distance of the total B12 in a product from the lower B12 threshold.

Product score=W1*S1+W2*S2 . . .

Optionally, the weights are adjusted according to the subject profile such as in the above stated case of treating different causes of anemia. Optionally, the product score is calculated as square root of sum of scores at second degree.

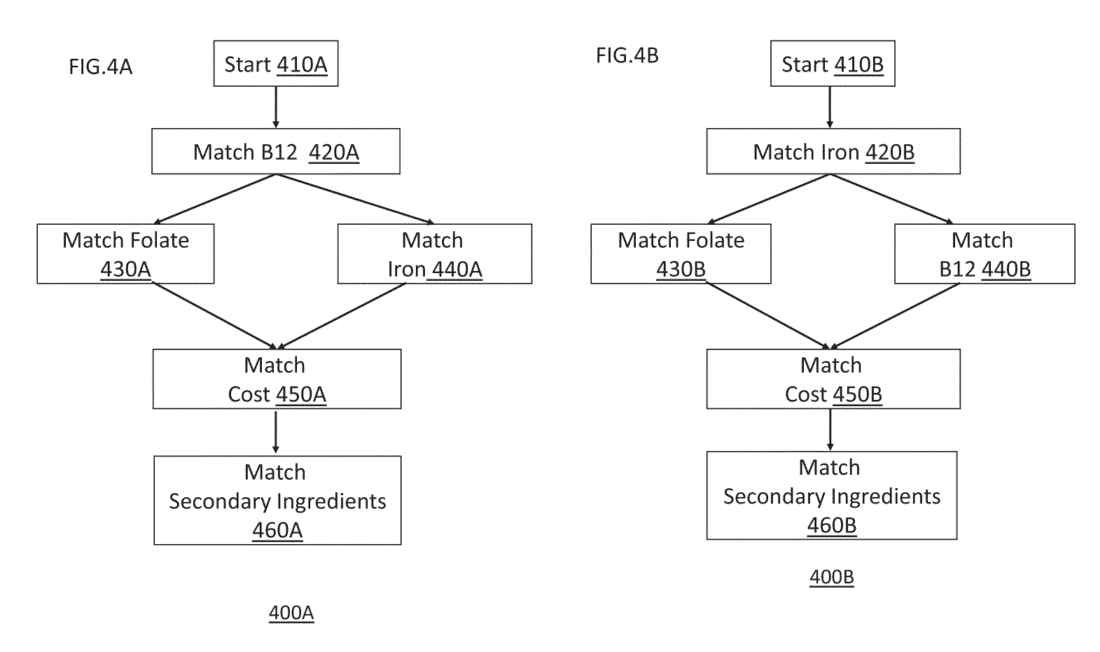

Optionally, product matching engine 260 performs a match between a product, its ingredients and their nutrimer profiles on one hand and a subject profile on the other hand using decision trees. For example, in order to treat Pernicious anemia and/or a more subtle decrease in hemoglobin and red blood cell production, caused by B12 insufficiency, product matching engine 260 applies the decision tree illustrated in FIG. 4A, in accordance with some embodiments of the present invention. Pernicious anemia is caused by lack of B12 vitamin. Accordingly, a respective decision tree 400A for product matching priorities B12 nutrimer product selection 420A over folate 430A and iron 440A selections. Other considerations, such as cost 450A and secondary ingredients are used to rank/score products with lower priority in decision tree 400A. As used herein the term secondary ingredients means ingredients not known to effect the condition or purpose of the product matching. For example, anti-oxidants such as ascorbic acid with respect to product matching for Pernicious anemia and/or mild decrease in hemoglobin and red blood cell production.

B12 nutrimer product selection 420A may be performed, for example, by following the subsequent criteria:
1. Choose features from subject profile to determine dosage (example: age, gender, pregnancy, lactation, baseline B12 blood level, B12 blood level fluctuation history, mal absorption status, contraception usage, administration presences, and/or intracellular B12 measurements).
2. Determine minimum B12 dosage from RDA table using gender and age In case of additional features an extended recommended intake table is provided with the relevant features as table categories. Optionally, the RDA table may be replaced by other optimal vitamin intake based on other more current and comprehensive scientific resources. Optionally, the estimation of the optimal intake dose is calculated by an algorithm rather than read from a table (as described further below).
3. Filter out products having total B12 below minimum B12 dosage.
4. Filter out products having total B12 above 10 mcg.
5. If genetic profile is:
   COMT rs4680 genotype is Met/Met: keep only hydroxycobalamin containing products.
   MTHFR rs1801133 genotype is TT: keep only methylcobalamin containing products.
   COMT rs4680 genotype is Met/Met and MTHFR rs1801133 genotype is TT than apply a policy such as, for example: a) Keep both hydroxycobalamin containing products and methylcobalamin containing products b) Keep products containing a combination of hydroxycobalamin and methylcobalamin etc.
   If genotype unknown: skip stage.
6. Score based on a combination of vitamer, dosage, administration, absorbance, adverse effect levels, or other factors. Sort and/or rank based on the calculated score. The score may be generated by a software module. For example, Sort by B12 nutrimer methylcobalamin>hydroxycobalamin>cyanocobalamin.
7. Within each sorted category: sort by method of administration, for example, by the following order sub-lingual administration<nasal administration<oral pills administration.

Optionally, B12 selection 420A may be performed by an algorithm such as:
1. Convert each ingredient dosage to normalized units according to the nutrimer sub type.
2. Sum nutrimers' dosages for nutrimers of the same nutrient type.
3. Calculate a score of the summed nutrients' dose from previous step (for example by a graph representing deviation from optimal intake as a dependency on nutrient dose).
4. Weight each nutrimer quality score according to its relative dose contribution.
5. Subtract from result of previous stage a negative effect of each nutrimer.
6. Sum all nutrients weighted by their relative contribution to an expected composition of a product.
7. Optionally, subtract the weighted score of unrelated ingredients.
8. Optionally, decrease the score for existence of manufacturing related ingredients such as flow agents (for example magnesium stearate).
9. Normalize scores to a desired user-informative range, such as 1 to 5 stars.

In order to treat Iron-deficiency anemia and/or a more subtle decrease in hemoglobin and red blood cell production caused by iron insufficiency, product matching engine 260 may apply a decision process, for example, calculating a score and sorting based on the scores, a decision tree (as illustrated in FIG. 4B, in accordance with some embodiments of the present invention), or other suitable decision methods. Accordingly, the respective decision tree 400B for product matching give priority to Iron nutrimer product selection 420B over folate 430B and B12 440B selections. The rest of the decision tree (410B, 450B, 460B) is as described for the Pernicious anemia product matching.

According to the Pernicious anemia decision tree 400A, the following product (product A) having its ingredients listed in Table 5 would be preferred over another product (product B) having its ingredients listed in Table 6, for a subject with an unknown genetic profile. According to the Pernicious anemia decision tree 400A, product A would get a lower rank than product B for a subject homozygous for rs1801133 T/T in the MTHFR gene. However product B would get a lower rank than product A for a subject homozygous for rs4680 158Met/Met in the COMT gene.

TABLE 5
Ingredients of product A

| | | |
|---|---|---|
| Folate (as folic acid) | 400 | mcg |
| Vitamin B12 (as methylcobalamin) | 400 | mcg |
| Iron (as aspartate, ferrous succinate, ferrous fumarate) | 25 | mg |

TABLE 6
Ingredients of product B

| | | |
|---|---|---|
| Folate (as folic acid) | 400 | mcg |
| Vitamin B12 (as hydroxycobalamin) | 400 | mcg |
| Iron (as aspartate, ferrous succinate, ferrous fumarate) | 25 | mg |

The product's ingredients may be ranked and/or otherwise scored according to relevance of treating a specific condition and/or genetic profile match.

Optionally, pills, lozenges, sprays, chewables (or other structures for enteral, nasal or other administration) are formed according to the matched commercially available supplemental products. Optionally, the amount and/or dose of the pills are selected according to the generation administration plan (e.g., as in block 721). Pills may be manufactured by a manufacturing facility, in bulk and/or customized per individuals. Pills may be manufactured at home by the user, by mixing the different products and forming the pills using a commercially available tablet manufacturing machine.

Optionally, pills are formed according to available products. For example, when a new product is available, pills may be formed using that product.

Optionally, limited numbers of pills are formed at a time (e.g., for a week, for two weeks, for a month, or other time frames). The number may be selected, for example, according to the amount of time that the products remain fresh, and/or according to changing health status of the subject (which may require changing pills) and/or according to updated research (which may suggest different pills).

Optionally, at 721, a recommended administration plan is automatically generated for the subject, for example, by plan generation module 224. The plan may be customized for the subject, and/or selected from one of several predefined plans. The plan includes, for example, amount of each of the nutrimers, consumption pattern of the nutrimers, frequency of administration of the nutrimers, other factors and/or combinations thereof.

Optionally, the plan includes one or more stages. The plan may include a first booster stage, to get the subject to a selected target. The plan may include a second maintenance stage, to maintain the subject at the selected target.

Optionally, the plan includes the matched supplemental products. Alternatively or additionally, the plan includes natural foods (e.g., fruits, nuts, meat, dairy, mushrooms, and/or fish) that contain the nutrimers. The plan may be a recommended diet.

Optionally, the plan is generated according to the health profile of the subject. For example, certain foods and/or products are avoided for patients with medical conditions, for example, conditions which may not have clearly associated genetic profiles (e.g., diabetics, high cholesterol, and/or obesity). Optionally, supplemental products are recommended based on the generated recommendation plan. The supplemental products may be selected by receiving diet information of the current diet of the subject (e.g., provided by the user, by an average diet such as based on general information such as country, health orientation or other factors), subtracting the current diet information (e.g., average intake) of the subject from the recommended plan to obtain a difference, and providing the difference as one or more supplemental products. In this manner, the user is provided with the missing components of the recommended plan.

Optionally, at 722, a match indication is provided for a product matched by the product matching engine with respect to a specific subject profile. Alternatively or additionally, the generated recommended administration plan is provided. Alternatively or additionally, the correlated nutrimers are provided, for example, to allow the healthcare provider to manually design the administration plan. A match indication may be, for example, a rank, a score, a match category, a match meter or other suitable indications A match indication may be, for example, displayed on a digital display such as a retailer website along with a product, a browser extension, a mobile application etc., printed in a personalized catalogue, printed on a product label along with a profile etc., outputted to the user on a screen, forwarded to another system (e.g., pharmacy), and/or stored on a local or remove memory for future use.

Optionally, the match indication and/or recommended administration plan are sent as alerts to an application running on a mobile device (e.g., smartphone, tablet) of the subject. For example, details of the upcoming dose of nutrimers are sent, for example, as images, as text messages, as voice recordings and/or combinations thereof.

Optionally, instructions for combining the commercial supplemental products are sent to the subject.

Referring back to FIG. 2, optionally, nutrimer matching system 200 comprises a decision control module 270 for enabling the user to influence features used by product matching engine 260. For example, the user may modify the degree of importance of a budget, prioritize conditions for treatment and/or indicate the level of scientific evidence that should be utilized. By allowing such modifications decision control module 270 may enable dynamic product matching by the product matching engine which suits a user desire. The user may be empowered to refine his/her needs according to real results of matched products provided in real time.

Optionally, an input interface 214 is in electrical communication with processor 210 to allow the user to control processor 210 and/or related program modules. Input interface 214 is, for example, a mouse, a keyboard, a touchscreen, voice recognition software, or other suitable input devices. Optionally, the input interface allows the operator to modify the nutrimer profile, the subject profile, and/or other information.

Optionally, an output interface 216 is in electrical communication with processor 210 provides output of the correlation results and/or other data. Interface 216 is, for example, a monitor, a printer, or other suitable output devices.

Optionally, a network interface 218 is in electrical communication with processor 210 to provide connectivity with other computers, for example, with remote servers by providing an internet connection and/or with local servers by providing a local area connection. Interface 218 provides wired and/or wireless connectivity.

Optionally, system 200 comprises an update module 222 for automatically updating nutrimer correlation database 220 and/or product storage module 250. Updates are performed, for example, by accessing a remote server using network interface 218 to automatically obtain updates from manufacturers, researches, clinical organizations, or other sources of updated data. Alternatively or additionally, module 222 periodically asks the user to manually enter updates.

Optionally, at 724, monitoring is performed. Examples of monitoring include, monitoring the health of the subject (e.g., using bloodwork), monitoring the age of the subject, monitoring medications of the subject, monitoring compliance of the subject with the recommended administration plan, monitoring changes to the nutrimer-genetic variation database (e.g., secondary to new research and/or new guidelines), monitoring availability of supplemental products, monitoring for new rules with respect to the correlations (e.g., new doses).

Optionally, monitoring is performed automatically, for example, through automatically generated software updates.

Optionally, the administration of the recommended plan is automatically managed, for example, by software. For example, alerts are automatically sent to the user to take the next dose of nutrimers. After taking the dose, the user acknowledges the alert by clicking a button on the alert. A report is automatically prepared and sent to the healthcare provider on compliance of the user.

Optionally, monitoring is performed to detect changes in the correlation of genetic variations with nutrimers, for example, based on new research. Optionally, a new match is generated accordingly based on the detected change, for example, by repeating one or more blocks of the method.

Optionally, at 726, the recommended administration plan is adjusted according to the monitoring (block 724). For example, different nutrients are selected, different doses are selected, different supplemental products are selected, or other factors and/or combinations thereof.

Alternatively or additionally, the matching is dynamically adjusted. Optionally, one or more rules are received from a user for the matching, for example, preferences for how to perform the matching, such as including different criteria during the matching. The rules may selected by the use from a checklist, manually entered, selected from a drop-down menu, or entered by other methods. The matched nutrimers may be dynamically changed based on the received rules, for example, re-matched, re-scored and/or re-sorted. The dynamic changes may be performed on-the-fly as the user provides different preferences. In this manner, the user may quickly see how different nutrimers are selected based on changes to preferences, to help select the desired nutrimers based on a suitable combination of rules. The dynamic adjustment may be performed for other parts of the process, for example, the recommended administration plan may be dynamically adjusted.

Optionally, one or more block of the method of FIG. 7 are repeated during the adjustment, for example, receiving an updated subject profiles (block 702), correlating using an updated correlation database (block 704), correlating according to new non-genetic data (block 714), other blocks and/or combinations thereof.

It is expected that during the life of a patent maturing from this application many relevant genetic variations, variation descriptors, nutrimers, nutrimer(s)-genetic variation(s) relationships, supplements, personalization characteristics and/or supplements administration methods will be developed and the scope of the terms genetic variations, variation descriptors, nutrimers, nutrimer(s)-genetic variation(s) relationships, supplements and/or supplements administration methods are intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the present invention may include a plurality of “optional” features unless such features conflict.

Throughout this application, various embodiments of this present invention may be presented in a range format. It should be understood that the description in range format is merely for convenience and brevity and should not be construed as an inflexible limitation on the scope of the present invention. Accordingly, the description of a range should be considered to have specifically disclosed all the possible subranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the present invention, which are, for clarity, described in the context of separate embodiments, may also be provided in combination in a single embodiment. Conversely, various features of the present invention, which are, for brevity, described in the context of a single embodiment, may also be provided separately or in any suitable subcombination or as suitable in any other described embodiment of the present invention. Certain features described in the context of various embodiments are not to be considered essential features of those embodiments, unless the embodiment is inoperative without those elements.

Although the present invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A computer-implemented method for selecting at least one nutrimer for a subject, the method being carried out by a nutrimer matching unit programmed to carry out the steps of the method, which comprise:
receiving at least one genetic variation of a subject;
automatically matching the at least one genetic variation with at least one nutrimer using a nutrimer correlation database storing a plurality of correlations of genetic variations with nutrimers; and
generating a signal indicative of the at least one matched nutrimer.

2. The method of claim 1, further comprising generating a recommended plan for administration of the at least one matched nutrimer to the subject.

3. The method of claim 2, wherein the recommended plan comprises one or more of: an amount of each of the nutrimers, a consumption pattern of the nutrimers, and a frequency of administration of the nutrimers.

4. The method of claim 1, wherein the nutrimer comprises at least one of: a vitamer, a mineral sub-type, an herbal sub-type, and a spices sub-type.

5. The method of claim 1, further comprising calculating a score for the at least one matched nutrimer based on desirability of administering the at least one matched nutrimer to the subject.

6. The method of claim 5, wherein the scores are based one or more of: metabolic pathways, metabolic products, bioavailability, side effects, costs, risk of toxicity, therapeutic effects, source, and manufacturing process.

7. The method of claim 1, wherein the automatically matching is performed according to at least one of a nutrimer profile and a subject profile.

8. The method of claim 7, wherein the nutrimer profile comprises at least one of: method of administration, bioavailability, toxicity, substance release mode, intake along with food, antagonist effect, agonist effect, source, manufacturing process, expiration date and inventory status; and the subject profile comprises at least one of: budget range, preferred method of administration, gender, age, pregnancy status, lactation status, physical activity, stress level, known allergies, suspected allergies, prescribed medications, over the counter drugs, eating habits, medical conditions, family history and medical history.

9. The method of claim 1, further comprising: assigning a product score to available products based on product profiles of the available products wherein the available products contain the at least one matched nutrimer, and wherein automatically matching comprises automatically matching the at least one genetic variation based on the product score.

10. The method of claim 1, wherein the subject is presumably healthy and the automatically matching is performed to maintain the health of the subject using the matched nutrimers.

11. The method of claim 1, further comprising:
receiving nutrimer ingredient data of at least one commercially available supplemental products;
classifying each of the commercially available supplemental products according to the nutrimer ingredient data; and
selecting at least one of the classified commercially available supplemental products according to the correlated nutrimer.

12. The method of claim 11, wherein the selecting is performed according to a product profile comprising at least one of: method of product administration, period of administration, frequency of administration, substance release mode, brand and cost.

13. The method of claim 11, further comprising providing instructions for combining the commercially available supplemental products into a recommended administration plan.

14. The method of claim 2, further comprising retrieving recommended doses for the nutrimer-genetic variation correlation and generating the recommended administration plan according to the recommended dose.

15. The method of claim 1, wherein automatically matching comprises automatically matching a combination of multiple genetic variations to a single nutrimer.

16. The method of claim 1, wherein automatically matching comprises automatically matching a single genetic variation to multiple nutrimers.

17. The method of claim 1, further comprising integrating multiple nutrimer-genetic variation correlations into a nutrimer regimen comprising a set of multiple nutritional supplements for intake by the subject.

18. The method of claim 1, wherein automatically matching comprises automatically matching according to nutrimer-nutrimer interactions.

19. The method of claim 1, further comprising receiving a medical profile of the subject including prescribed medications, and generating a recommended plan for administration of the at least one matched nutrimer to the subject in accordance with the medical profile.

20. The method of claim 19, wherein automatically matching comprises automatically matching according to medication-nutrimer interactions.

21. The method of claim 1, wherein automatically matching comprises matching the nutrimers according to an indirect supplementation protocol.

22. The method of claim 1, wherein automatically matching comprises matching the nutrimers according to epistasis.

23. The method of claim 1, wherein automatically matching comprises matching according to clinical guidelines and/or according to health organization recommendations.

24. The method of claim 2, wherein outputting comprises generating alerts indicative of the recommended administration plan to a mobile device of the subject.

25. The method of claim 2, further comprising automatically managing the administration of the recommended plan.

26. The method of claim 1, further comprising receiving from a user at least one rule for the respective matching, and dynamically changing the at least one matched nutrimer based on the received at least one rule.

27. The method of claim 2, further comprising receiving from a user at least one preference related to the recommended administration plan, and dynamically changing the recommended administration plan according to the at least one preference.

28. The method of claim 27, wherein the at least one preference is in response to change in health status of the subject.

29. The method of claim 2, wherein the recommended administration plan comprises a booster stage and a maintenance stage.

30. The method of claim 2, wherein the recommended plan includes a diet based on the matched nutrimers.

31. The method of claim 2, further comprising receiving intake diet information of the subject, subtracting the intake diet information from the recommended plan to obtain a difference, and providing the difference as one or more supplemental products.

32. The method of claim 1, wherein matching further comprises matching according to an dietary intake based nutrimer profile that indicates which nutrimer and amount is to be administered for: different ages, gender, pregnancy status, and/or lactation status.

33. The method of claim 1, further comprising monitoring for changes in the correlations of genetic variations with nutrimers and generating at least one new matched nutrimer accordingly.

34. The method of claim 2, further comprising monitoring for changes in the correlations of genetic variations with nutrimers and generating a new recommended administration plan accordingly.

35. The method of claim 1, further comprising receiving input from an operator to modify one or both of a nutrimer profile and a subject profile.

36. A system for automatic matching of at least one nutrimer according to a genetic profile of a subject, the system comprising:
a hardware processor; and
a non-transitory memory having stored thereon program modules for instruction execution by the hardware processor, comprising:
a nutrimer correlation database storing correlations of genetic variations with nutrimers; and
a nutrimer matching module for matching at least one genetic variation of a subject with at least one nutrimer using the nutrimer correlation database.

37. The system of claim 36, further comprising a recommendation plan generation module for generating a recommended plan for administration of the at least one nutrimer to the subject.

38. The system of claim 36, further comprising an input interface for allowing an operator to modify one or both of a nutrimer profile and a subject profile.

39. The system of claim 36, further comprising a network interface for connecting to a network, and further comprising an update module for accessing a remote server using the network interface to obtain data for updating the nutrimer correlation database.

40. A method for generating a kit of structures for enteral administration comprising:
receiving at least one genetic variation of a subject;
automatically matching the at least one genetic variation with at least one nutrimer;
receiving nutrimer ingredient data of at least one commercially available supplemental products;
selecting at least one of the commercially available supplemental products according to the at least one matched nutrimer; and
forming structures for enteral administration out of the commercially available supplemental products having the at least one matched nutrimers.

41. The method of claim 40, further comprising generating a recommended plan for administration of the at least one matched nutrimer to the subject based on the formed structures for enteral administration.
